(19) United States
(12) Patent Application Publication
(10) Pub. No.: US 2024/0272697 A1
(43) Pub. Date: Aug. 15, 2024

(54) Electronic Devices With Enclosure-Based Power Consumption

(71) Applicant: Apple Inc., Cupertino, CA (US)

(72) Inventors: Xiaoyuan Tu, Palo Alto, CA (US); Anna E Craig, Redwood City, CA (US); Evan G Kriminger, San Francisco, CA (US)

(21) Appl. No.: 18/534,445

(22) Filed: Dec. 8, 2023

Related U.S. Application Data
(60) Provisional application No. 63/484,154, filed on Feb. 9, 2023.

(51) Int. Cl. G06F 1/3231; G06F 1/3234; H04W 52/02

(52) U.S. Cl. CPC G06F 1/3231; G06F 1/3265; H04W 52/0254

(57) ABSTRACT

An electronic device may have a battery that powers one or more components, such as a display, sensors, or input-output devices, in the device. It may be desirable to reduce power consumption of the battery in certain situations. For example, it may be desirable to reduce power consumption when the electronic device is enclosed, such as in a pocket, in a bag, or covered by a sleeve. To determine whether the device is enclosed, a pressure sensor and/or an accelerometer may be used to gather pressure measurements and/or motion measurements while the device is in motion. A controller may analyze these measurements in a temporal and/or a spectral space to determine whether the device is enclosed. Other sensor information, such as ambient light measurements, may also be used in the enclosure determination. In response to determining that the device is enclosed, the controller may power consumption.

This application claims the benefit of U.S. provisional application No. 63/484,154, filed Feb. 9, 2023, which is hereby incorporated by reference herein in its entirety.

### FIELD

This relates generally to electronic devices, and, more particularly, to electronic devices with adjustable power consumption.

### BACKGROUND

Electronic devices such as laptop computers, cellular telephones, and other equipment are sometimes provided with various components. The components may be adjusted based on sensor measurements.

### SUMMARY

An electronic device may have a housing and a battery in the housing that powers one or more components. It may be desirable to reduce power consumption of the battery when the electronic device is enclosed, such as in a pocket, in a bag, or covered by a sleeve. To determine whether the device is enclosed, a pressure sensor may be used to gather pressure measurements while the device is moving. In response to determining that the device is enclosed, power consumption may be reduced.

A motion sensor, such as an accelerometer, may be used to determine that the device is moving, and may also be used to determine whether the device is enclosed.

A controller may analyze the pressure and/or motion measurements in a temporal and/or a spectral space to determine whether the device is enclosed. For example, amplitudes of the pressure and/or accelerometer data in the temporal space may indicate that the device is enclosed during those times. Alternatively, sets of data in the spectral space may indicate that the enclosure condition of the device when the measurements were taken.

The battery may power any desired component, such as a display, wireless communications circuitry, a sensor, or an input device. For example, the component may include a display, such as an always-on display. The always-on display may be operable in an always-on mode, in which the display may be fully-on (e.g., when a user is looking at or using the display) or in a low-power mode. Alternatively or additionally, the component may include a microphone or a camera, and the component may be deactivated when the device is enclosed.

Other sensor information, such as ambient light measurements, may also be used in the enclosure determination. In response to determining that the device is enclosed, the controller may deactivate or otherwise adjust the display.

### BRIEF DESCRIPTION OF THE DRAWINGS

FIG. 1 is a schematic diagram of an illustrative electronic device having a display and sensor components in accordance with some embodiments.

FIG. 2 is a perspective view of an electronic device with a display in accordance with some embodiments.

FIG. 3 is a perspective view of a wearable electronic device with a display in accordance with some embodiments.

FIG. 4 is a graph of an illustrative temporal relationship between pressure and enclosure condition of a device in accordance with some embodiments.

FIG. 5 is a graph of an illustrative temporal relationship between acceleration and enclosure condition of a device in accordance with some embodiments.

FIG. 6 is a graph of an illustrative spectral relationships between the pressure and acceleration power that vary with enclosure conditions of a device in accordance with some embodiments.

FIG. 7 is a diagram of illustrative pressure, motion, and light sensor components used to determine whether a device is enclosed in accordance with some embodiments.

FIG. 8 is a flowchart of illustrative steps that may be used to determine whether a device is enclosed and to adjust power consumption in accordance with some embodiments.

### DETAILED DESCRIPTION

Electronic devices, such as cellular telephones, tablets, and wearable devices, may have one or more components that are powered by a battery. In some situations, it may be desirable to reduce power consumption of the battery when the electronic device is enclosed. As used herein, a device may be enclosed if it is partially or entirely within an enclosed space, such as a pocket, bag, or purse, or overlapped by a sleeve or other material. For example, a device may be partially inside a bag or pocket (e.g., a first portion of the device may be inside of the bag or pocket and a second portion of the device may be outside of the bag or pocket). Alternatively, the device may be entirely within the bag or pocket. In these situations, it may be desirable to reduce power consumption by deactivating or otherwise reducing power requirements of a component in the device.

To determine whether the device is enclosed, a pressure sensor may be used to gather pressure measurements while the device is moving. In response to determining that the device is enclosed, power consumption may be reduced. An ambient light sensor, a motion sensor, and/or other desired sensors also may be used to determine whether the device is enclosed, if desired. For example, pressure sensor data and motion sensor data may be analyzed temporally and/or spectrally to determine whether the device is enclosed while the device is in motion. After determining that the device is enclosed, a controller in the device may reduce power consumption.

The controller may reduce power consumption by adjusting a display, sensor, communications circuitry, input device, or other component. For example, the power requirements of wireless communications circuitry, device sensors, and/or device input-output devices may be reduced in response to determining that the device is enclosed.

In some embodiments, an electronic device may include an always-on display. For example, an always-on display may be fully on when in use (e.g., all of the pixels in the display or a substantial number of pixels in the display may display images for a user), and may have a low-power state when not in use (e.g., a smaller number of pixels may display important information, such as the time, date, messages, or other important alerts, or the pixels may be at a reduced light emission intensity).

In some situations, however, it may be desirable to turn the always-on display completely off. In other words, it may be desirable to deactivate the always-on display by turning the pixels of the always-on display off. For example, if a device is enclosed, as described herein, such as in a pocket, bag, purse, or other enclosed space, the device may not be visible to a user. In these situations, in which the device is enclosed, it may be desirable to deactivate the display to conserve power (e.g., power stored by a battery in the electronic device housing).

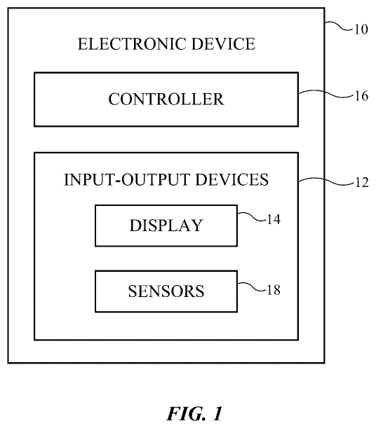

An illustrative electronic device of the type that may be provided with sensors to determine whether the device is enclosed is shown in FIG. 1. Electronic device 10 may be a computing device such as a laptop computer, a computer monitor containing an embedded computer, a tablet computer, a cellular telephone, a media player, or other handheld or portable electronic device, a smaller device such as a wristwatch or other device worn on a user's wrist, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, or other electronic equipment.

As shown in FIG. 1, electronic device 10 may have controller 16 (also referred to as control circuitry herein). Controller 16 may include storage and processing circuitry for supporting the operation of device 10. The storage and processing circuitry may include storage such as hard disk drive storage, nonvolatile memory (e.g., flash memory or other electrically-programmable-read-only memory configured to form a solid-state drive), volatile memory (e.g., static or dynamic random-access-memory), etc. Processing circuitry in controller 16 may be used to control the operation of device 10. The processing circuitry may be based on one or more microprocessors, microcontrollers, digital signal processors, baseband processors, power management units, audio chips, application specific integrated circuits, etc. Controller 16 may include communications circuitry for supporting wired and/or wireless communications between device 10 and external equipment. For example, controller 16 may include wireless communications circuitry such as cellular telephone communications circuitry and wireless local area network communications circuitry. The communications circuitry may include one or more antennas that send and/or receive data or other information from external sources.

Input-output devices 12 may be used to allow data to be supplied to device 10 and to allow data to be provided from device 10 to external devices. Input-output devices 12 may include buttons, joysticks, scrolling wheels, touch pads, key pads, keyboards, microphones, speakers, tone generators, vibrators, cameras, light-emitting diodes and other status indicators, data ports, etc. A user may control the operation of device 10 by supplying commands through input-output devices 12 and may receive status information and other output from device 10 using the output resources of input-output devices 12.

Input-output devices 12 may include one or more displays such as display 14. Display 14 may be a touch screen display that includes a touch sensor for gathering touch input from a user (e.g., a user's finger, a stylus, or other input device) or display 14 may be insensitive to touch. A touch sensor for display 14 may be based on an array of capacitive touch sensor electrodes, acoustic touch sensor structures, resistive touch components, force-based touch sensor structures, a light-based touch sensor, or other suitable touch sensor arrangements. Display 14 may be include any desired display technology, and may be an organic light-emitting diode (OLED) display, a liquid crystal display (LCD), a microLED display, or any other desired type of display.

In some embodiments, display 14 may be an always-on display. For example, display 14 may be fully on when in use and may have a low-power state when not in use. In the fully-on state, all of the pixels or a substantial number of the pixels in display 14 may display images for a user. In the low-power state, a smaller number of pixels may display important information, such as the time, date, messages, or other notifications. In an illustrative embodiment, a majority of pixels may be off in the low-power state, and the pixels that are on may emit less light than in the fully-on state. In general, however, any number of pixels may be used to display images or other information in the fully-on state and/or the low-power state.

Display 14 may be adjusted between the fully-on and low-power states based on information from sensors in electronic device 10 (such as sensors 18). For example, sensors in device 10 may indicate that a user is holding or looking at display 14, in which case display 14 may be placed in the fully-on state, or sensors in device 10 may indicate that the user is not holding and/or looking at display 14, in which case display 14 may be placed in the low-power state.

Sensors 18 may include a capacitive sensor, a light-based proximity sensor, a magnetic sensor (e.g., a magnetometer or a compass), an accelerometer or other motion sensor, a force sensor, a touch sensor, a temperature sensor, a pressure sensor, a microphone, a radio-frequency sensor, a three-dimensional image sensor, an ambient light sensor, a camera, a light-based position sensor (e.g., a lidar sensor), and/or other sensors. Sensors 18 may include one or more of each of these sensors, if desired. A battery in device 10 may store power that is used to power display 14, sensors 18, and other components of device 10.

In operation, one or more sensors 18 may be used to determine whether device 10 is enclosed, such as in a pocket or bag. For example, a pressure sensor, an accelerometer, and/or an ambient light sensor may be used to determine whether device 10 is enclosed, such as partially or entirely within a pocket, bag, or partially or entirely overlapped by a sleeve or other material. In response to determining that device 10 is enclosed, controller 16 may adjust one or more components within device 10 to reduce the power consumption of the battery in device 10. For example, controller 16 may adjust display 14, such as by switching display 14 from an always-on mode to a deactivated mode. In the deactivated mode, all of the pixels of display 14 may be off to conserve power.

In another example, controller 16 may adjust one or more antennas in the device (e.g., in the antennas of the wireless communications circuitry of controller 16), such as by deactivating or reducing the power of the antennas when the device is enclosed. In other embodiments, controller 16 may alternatively or additionally adjust the monitoring of user activity (e.g., adjust a sensor that is used to monitor a user, such as one of sensors 18), such as steps taken by the user, when the device is enclosed. In other embodiments, a sensor or other component, such as a camera, a microphone, a flashlight, or a speaker, may be prevented from being activated when the device is enclosed. In general, any desired function(s) of the device may be adjusted in response to determining that the device is enclosed.

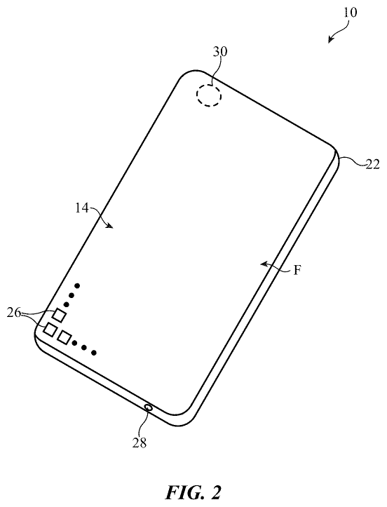

A perspective view of an illustrative electronic device of the type that may include sensors for determining whether the device is enclosed is shown in FIG. 2. In the example of FIG. 2, device 10 includes a display such as display 14 mounted in housing 22. Display 14 may be a liquid crystal display, an electrophoretic display, an organic light-emitting diode display, or other display with an array of light-emitting diodes (e.g., a display that includes pixels having diodes formed from crystalline semiconductor dies), may be a plasma display, may be an electrowetting display, may be a display based on microelectromechanical systems (MEMs) pixels, or may be any other suitable display. Display 14 may have an array of pixels 26 that extends across some or all of front face F of device 10 and/or other external device surfaces. The pixel array may be rectangular or may have other suitable shapes. Display 14 may be protected using a display cover layer (e.g., a transparent front housing layer) such as a layer of transparent glass, clear plastic, sapphire, or another clear layer. The display cover layer may overlap the array of pixels 26.

Housing 22, which may sometimes be referred to as an enclosure or case, may be formed of plastic, glass, ceramics, fiber composites, metal (e.g., stainless steel, aluminum, etc.), other suitable materials, or a combination of any two or more of these materials. Housing 22 and display 14 may separate an interior region of device 10 from an exterior region surrounding device 10. Housing 22 may be formed using a unibody configuration in which some or all of housing 22 is machined or molded as a single structure or may be formed using multiple structures (e.g., an internal frame structure, one or more structures that form exterior housing surfaces, etc.).

Pixels 26 may cover substantially all of the front face of device 10 or display 14 may have inactive areas (e.g., notches, recessed areas, rectangular areas, or other regions) that are free of pixels 26. The inactive areas may be used to accommodate an opening for a speaker and windows for optical components such as one or more image sensors, ambient light sensors, optical proximity sensors, three-dimensional image sensors such as structured light three-dimensional image sensors, and/or a camera flash, etc. In an illustrative configuration, pixels 26 may extend over the entirety of the front surface F of device 10 and may overlap an ambient light sensor in region 30. In this type of arrangement, ambient light may pass to the ambient light sensor in region 30 through the array of pixels 26 in display 14. Alternatively, region 30 may be in an inactive area of display 14.

In addition to the ambient light sensor in region 30, device 10 may include a pressure sensor 28. For example, pressure sensor 28 may be a barometer, piezoelectric pressure sensor, or other desired pressure sensor and may be formed in an opening in housing 22. Pressure sensor 28 may generate signals in response to pressure in the exterior of device 10.

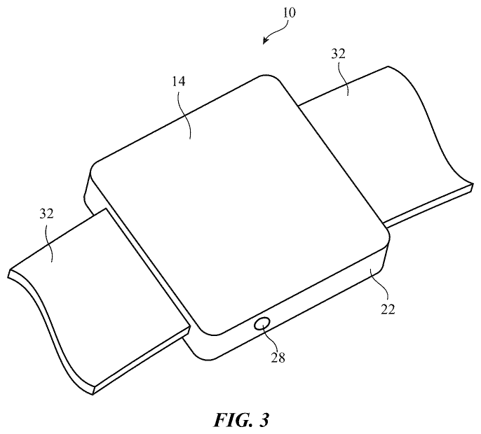

Although FIG. 2 shows electronic device 10 as a cellular telephone, this arrangement is merely illustrative. In general, electronic device 10 may be any electronic device. As shown in illustrative FIG. 3, for example, device 10 may be a wearable electronic device, such as a wristwatch device.

As shown in FIG. 3, electronic device 10 may have housing 22 which includes display 14 and pressure sensor 28. Electronic device 10 may also include an ambient light sensor, if desired.

Bands 32 may be coupled to housing 22. For example, bands 22 may be formed from fabric, leather, metal, or other material. Bands 32 may be used to couple device 10 to a body part of a user, such as the user's wrist.

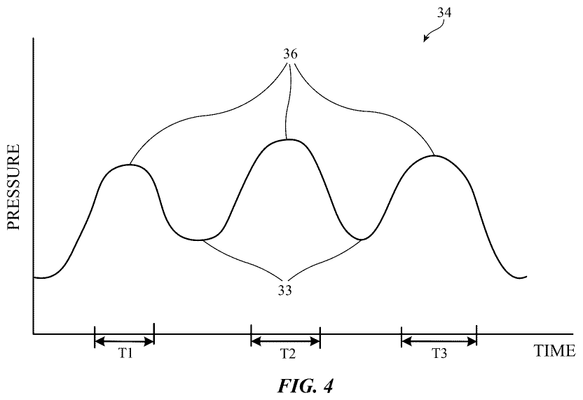

Regardless of the type of electronic device used, it may be desirable to determine whether the electronic device is enclosed, such as fully or entirely within a pocket, in a bag, or covered by a user's sleeve. To determine whether the device is enclosed, a sensor, such as one of sensors 18 of FIG. 1, may be used. In some embodiments, a pressure sensor may be used to determine whether the device is enclosed while the device is moving (e.g., while a housing of the device is in motion within the enclosure, or while the housing is in motion with the enclosure). An illustrative temporal relationship of pressure during different enclosure conditions is shown in FIG. 4.

As shown in FIG. 4, graph 34 may be a temporal (time-based) representation of pressure. For example, graph 34 shows how pressure (e.g., pressure signals/data generated by a pressure sensor in device 10) varies over time in different operating conditions. In particular, times (e.g., periods of time) T1, T2, and T3 may correspond to times in which device 10 is enclosed, such as fully or entirely within a bag, a pocket, or covered by a sleeve. There may be local maxima 36 of the pressure signals during periods of time T1, T2, and T3. In contrast, the times between T1 and T2, and between T2 and T3, may correspond to times in which device 10 is not enclosed. There may be local minima 33 of the pressure signals during these times.

Based on the variance of pressure signals temporally, it may be determined whether a device is enclosed or not. For example, a controller in device 10 may analyze measurements produced by one or more pressure sensors while device 10 is in motion to determine whether device 10 is enclosed. Relationships between pressure and enclosure status while the device is moving may be determined by machine learning, empirically, and/or by another desired method, and the relationships may be stored in device 10, such as in a look-up table. In operation, the controller may determine the enclosure status of device 10 based on the stored relationships.

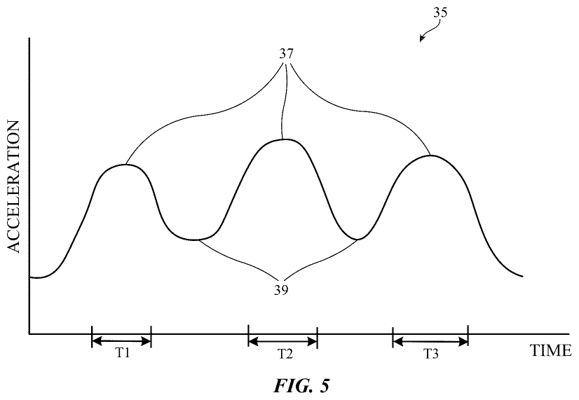

Although pressure sensor(s) may be used in determining whether an electronic device is enclosed, one or more other sensors may be used. For example, motion data from a motion sensor may be used. The motion sensor may be an accelerometer, gyroscope, or other desired motion sensor. An illustrative temporal relationship of accelerometer data during different enclosure conditions is shown in FIG. 5.

As shown in FIG. 5, graph 35 may be a temporal (time-based) representation of accelerometer (or other motion) data. For example, graph 35 shows how motion (e.g., motion signals/data generated by an accelerometer in device 10) varies over time in different operating conditions. In particular, times (e.g., time periods) T1, T2, and T3 may correspond to times in which device 10 is being moved while enclosed, such as entirely or partially within a bag, a pocket, or covered by a sleeve. There may be local maxima 37 of the accelerometer signals during time periods T1, T2, and T3. In contrast, the times between T1 and T2, and between T2 and T3, may correspond to times in which device 10 is not in motion. There may be local minima 39 of the accelerometer signals during these times.

In some embodiments, the temporal motion data of FIG. 5 may be used in combination with the temporal pressure data of FIG. 4 to determine whether a device is enclosed and moving within an enclosure, such as partially or entirely within a pocket or bag. Relationships between pressure and motion data, and enclosure/movement status may be determined by machine learning, empirically, and/or by another desired method, and the relationships may be stored in device 10, such as in a look-up table. In operation, the controller may determine the enclosure and movement status of device 10 based on the stored relationships.

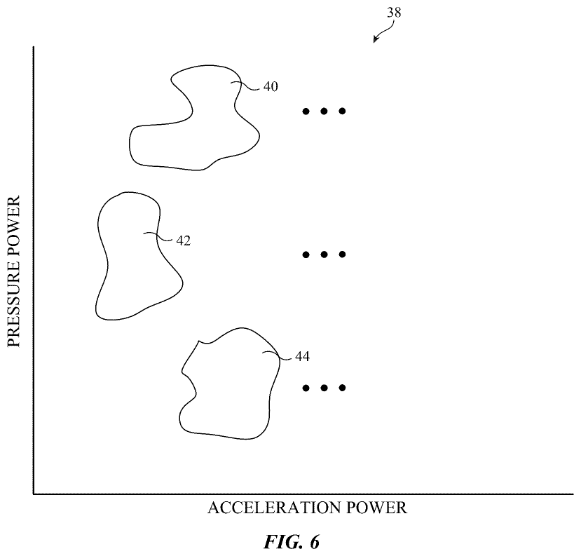

Although FIGS. 4 and 5 show that pressure and/or motion data may be used temporally to determine whether an electronic device is enclosed and/or moving while enclosed, sensor data may be used spectrally, if desired. For example, the power of the pressure signal in different frequency bands, the power of the motion signals in different frequency bands, and the correlations between these two sets of powers may be used to determine whether the device is enclosed while the device is moving. An illustrative spectral relationship between pressure and/or motion signals in different enclosure conditions is shown in FIG. 6.

As shown in FIG. 6, graph 38 may be a spectral (frequency-based) representation of pressure and accelerometer power data. The power data for the pressure and accelerometer data may be determined by applying a Fourier transform to the pressure and accelerometer data, as an example. If both pressure and accelerometer power data are used together, the pressure and accelerometer power data may be multiplied or otherwise combined.

There may be multiple sets of data when the pressure and accelerometer power data are correlated. As shown in FIG. 6, there may be three sets of data, sets 40, 42, and 44. Each set of data may correspond with a different enclosure condition of device 10. For example, set 40 may correspond to measurements that are taken when device 10 is entirely enclosed, set 42 may correspond to measurements that are taken when device 10 is partially enclosed (e.g., part of the way out of a pocket or bag), and set 44 may correspond to measurements that are taken when device 10 is not enclosed (e.g., in a user's hand or on a table). In some embodiments, sets 40, 42, and 44 may correspond to conditions in which device 10 is enclosed and moving. However, these sets of spectral data are merely illustrative. In general, relationships between power data and any enclosure conditions may be determined.

Based on the variance of pressure and/or accelerometer signals spectrally, it may be determined whether a device is enclosed or not while the device is moving. For example, a controller in device 10 may analyze measurements produced by a pressure sensor and one or more motion sensors determine whether device 10 is enclosed. Specific relationships between pressure data, motion data, and enclosure status may be determined by machine learning, empirically, and/or by another desired method, and the relationships may be stored in device 10, such as in a look-up table. In operation, the controller may determine the enclosure status of device 10 based on the stored relationships.

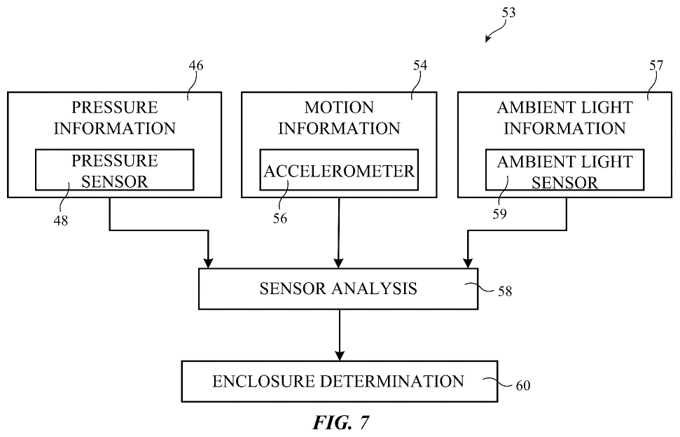

Regardless of whether temporal or spectral data is used, illustrative schematic diagram 53 in FIG. 7 shows how pressure information 46 may be obtained from pressure sensor 48, motion information 54 may be obtained from accelerometer 56, and ambient light information 57 may be obtained from ambient light sensor 59. Pressure sensor 48 may correspond with pressure sensor 28 of FIGS. 2 and 3, as examples.

Pressure sensor 48 may generate signals in response to pressure at the exterior of an electronic device, such as device 10 (FIG. 1). Accelerometer 56 may generate signals in response to motion of the device (e.g., motion of the housing of the device), such as device 10. Ambient light sensor 59 may generate signals in response to ambient light (e.g., the brightness/intensity of light outside of the device). These signals may be analog or digital signals, and may form pressure data, accelerometer data, and ambient light data, respectively.

Sensor analysis 58 may analyze the signals/data generated by pressure sensor 48, accelerometer 56, and/or ambient light sensor 59. In particular, a controller, such as controller 16 in device 10 (FIG. 1), may analyze the pressure data and/or the accelerometer data in a temporal and/or spectral space. In a temporal space, the controller may determine whether the pressure data and/or the accelerometer data falls within a certain range or meets a certain threshold (e.g., the maxima 36 of FIG. 4 and/or the maxima 37 of FIG. 5) that indicates that the device is enclosed and/or moving while enclosed. In a spectral space, the controller may determine a power of the pressure data and the accelerometer data (e.g., through a Fourier transform) and may determine whether the power of the pressure and accelerometer data fall within an expected set of data (e.g., one of the sets of data in FIG. 5). In some embodiments, the analysis may be performed in both the temporal and spectral space to improve the accuracy of the enclosure determination. Based on the temporal and/or spectral analysis, enclosure determination 60 may be made. In this way, the controller may determine whether the device is enclosed, such as entirely or partially within a pocket or bag, and/or moving while enclosed.

In some embodiments, the ambient light data may also be used in making enclosure determination 60. For example, if ambient light data indicates that the electronic device is in a dark space, it may be more likely that the device is enclosed. Alternatively, if ambient light data indicates that the electronic device data is in a well-lit space, it may be more likely that the device is not enclosed. The controller may use the ambient light data to confirm the enclosure determination that would otherwise be made based on the pressure and/or accelerometer data. Alternatively, the controller may correct the enclosure determination that would otherwise be made based on the pressure and/or accelerometer data (e.g., by comparing the ambient light data with stored information regarding expected light data at different enclosure conditions).

If desired, the controller may adjust a display of the electronic device (e.g., display 14 of FIG. 1) based on enclosure determination 60. For example, the controller may adjust the display between an always-on mode and a deactivated mode based on enclosure determination 60.

Using the pressure sensor, accelerometer, and/or ambient light sensor information to determine whether the device is enclosed may result in an accuracy of at least 98% or at least 99%, as examples.

Although FIG. 7 shows the use of pressure information, motion information, and ambient light information in making enclosure determination 60, any one or more of the pressure information, motion information, and/or ambient light information may be used in making enclosure determination 60. Additionally or alternatively, other sensor information may be used in making enclosure determination 60. In general, data from other sensors may be used in combination with the pressure data, if desired. For example, motion sensor data (e.g., accelerometer, gyroscope, or other motion sensor data), ambient light sensor data, proximity sensor data, magnetometer data, or other desired data may be used in determining whether the device is enclosed.

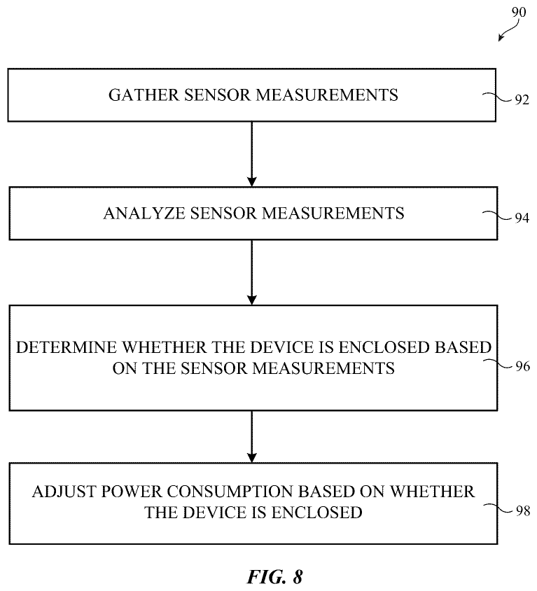

Regardless of the sensor(s) used in determining whether an electronic device is enclosed, illustrative steps that may be used to make an enclosure determination and to adjust the device based on the enclosure determination are shown in FIG. 8.

As shown in method 90 of FIG. 8, at step 92, one or more sensors in an electronic device may gather sensor measurements. The sensor(s) may include a pressure sensor, an accelerometer, an ambient light sensor, a gyroscope, a magnetometer, a proximity sensor, and/or other desired sensor(s). The sensor measurements may be analog or digital signals, and may form sensor data. For example, pressure data, motion data, and/or ambient light data may be gathered.

At step 94, the sensor measurements/data may be analyzed. For example, a controller, such as controller 16 in device 10 (FIG. 1), may analyze the pressure data and motion data in a temporal and/or spectral space. In a temporal space, the controller may determine whether the pressure data and/or the motion data fall within a certain range or meets a certain threshold (e.g., the maxima 36 of FIG. 4) that indicates that the device is enclosed and/or moving while enclosed. In a spectral space, the controller may determine a power of the pressure data and a power of the motion data (e.g., through a Fourier transform) and may determine whether the pressure data and motion data fall within an expected set of data (e.g., one of the sets of data in FIG. 5). In some embodiments, the analysis may be performed in both the temporal and spectral space to improve the accuracy of the enclosure determination.

At step 96, based on the temporal and/or spectral analysis of the sensor measurements, it may be determined whether the device is enclosed. For example, the controller may determine whether the device is enclosed, such as entirely or partially within a pocket, within a bag, or covered by a sleeve, and/or moving while enclosed. In some embodiments, the temporal and/or spectral analysis of the sensor measurements may be used to determine whether the device is enclosed while moving (e.g., while moving within the enclosure, or moving with the enclosure).

At step 98, power consumption may be adjusted based on whether the device is enclosed. For example, a controller in the device may deactivate any desired components or reduce power requirements of those components, in response to determining that the device is enclosed.

In some embodiments, the controller may adjust one or more antennas in the device (e.g., in the antennas of the wireless communications circuitry of controller 16 (FIG. 1)), such as by deactivating or reducing the power of the antennas when the device is enclosed. In other embodiments, the controller may alternatively or additionally adjust the monitoring of user activity (e.g., adjust a sensor that is used to monitor a user, such as one of sensors 18 of FIG. 1), such as steps taken by the user, when the device is enclosed. In other embodiments, a sensor or other component, such as a camera, a flashlight, or a speaker, may be prevented from being activated when the device is enclosed. In general, any desired function(s) of the device may be adjusted in response to determining that the device is enclosed.

In some embodiments, a display in the device may be adjusted based on whether the device is enclosed. For example, the display may be an always-on display. In response to determining that the device is enclosed, however, the controller may deactivate the always-on display (e.g., switching the always-on display from an always-on mode to a deactivated mode by turning all of the pixels of the display off). In particular, because the device is enclosed, such as entirely or partially in a bag, in a pocket, or covered by a sleeve, the display may not be visible to a user. Therefore, the always-on functionality, which may usually place the display is a low-power mode if the user is not actively using or looking at the device, may be deactivated in response to determining that the device is enclosed.

In some embodiments, adjusting power consumption of the electronic device may include altering a user interaction mode of the electronic device. A user interaction mode may include voice interaction, touch interaction, visual interaction, etc. For example, altering the user interaction mode can include altering from a visual interaction mode (e.g., a mode that involves a display in the electronic device) to a voice interaction mode (e.g., a mode that involves a microphone and/or speaker of the electronic device, or an external microphone and speaker) when the device is determined to be enclosed. In another example, altering the user interaction mode can include altering from a visual interaction mode, such as displaying images on a display, to a touch interaction mode when the device is determined to be enclosed.

The foregoing is merely illustrative and various modifications can be made to the described embodiments. The foregoing embodiments may be implemented individually or in any combination.

What is claimed is:

1. An electronic device, comprising:
a housing;
a battery that provides power to a component in the housing;
a pressure sensor in the housing; and
a controller in the housing, wherein the controller is configured to determine whether the housing is enclosed during movement of the housing in response to measurements from the pressure sensor, and is configured to reduce power consumption of the battery in response to determining that the housing is enclosed.

2. The electronic device of claim 1, further comprising:
a motion sensor in the housing configured to measure the movement of the housing, wherein the controller is further configured to determine whether the housing is enclosed in response to measurements from the motion sensor.

3. The electronic device of claim 2, wherein the motion sensor comprises an accelerometer.

4. The electronic device of claim 2, further comprising:
an ambient light sensor in the housing, wherein the controller is further configured to determine whether the housing is enclosed in response to measurements from the ambient light sensor.

5. The electronic device of claim 1, wherein the component comprises an always-on display.

6. The electronic device of claim 5, wherein the controller is configured to place the always-on display in a deactivated mode in response to determining that the housing is enclosed.

7. The electronic device of claim 1, wherein the component comprises wireless communications circuitry, wherein the wireless communications circuitry is configured to be adjusted in response to determining that the housing is enclosed.

8. The electronic device of claim 1, wherein the component comprises a sensor, wherein the sensor is configured to be adjusted in response to determining that the housing is enclosed.

9. The electronic device of claim 1, wherein the component comprises an input device.

10. The electronic device of claim 9, wherein the input device comprises a microphone.

11. A method of adjusting power consumption of a battery in an electronic device based on information from a pressure sensor, comprising:
gathering pressure measurements with the pressure sensor while the electronic device is moving;
determining whether the electronic device is enclosed based on the pressure measurements; and
adjusting the power consumption of the battery in response to determining that the electronic device is enclosed.

12. The method of claim 11, further comprising:
gathering light measurements with an ambient light sensor, wherein determining whether the electronic device is enclosed is based on the light measurements and the pressure measurements.

13. The method of claim 12, further comprising:
gathering motion measurements with a motion sensor, wherein determining whether the electronic device is enclosed is based on the motion measurements, the pressure measurements, and the light measurements.

14. The method of claim 11, further comprising:
gathering motion measurements with a motion sensor; and
determining that the electronic device is moving based on the motion measurements.

15. The method of claim 14, wherein determining whether the electronic device is enclosed comprises analyzing periods of time of the motion measurements and the pressure measurements in a temporal space.

16. The method of claim 14, wherein determining whether the electronic device is enclosed comprises analyzing sets of the motion measurements and the pressure measurements in a temporal and spectral space.

17. The method of claim 11, wherein adjusting the power consumption of the battery comprises reducing the power requirements of a component in the electronic device.

18. The method of claim 11, wherein adjusting the power consumption of the battery comprises altering a user interaction mode of the electronic device.

19. An electronic device, comprising:
a housing;
a display in the housing;
a battery that provides power to the display;
a pressure sensor in the housing;
a motion sensor in the housing; and
a controller in the housing, wherein the controller is configured to determine whether the housing is moving in response to measurements from the motion sensor, to determine whether the housing is enclosed in response to measurements from the pressure sensor while the housing is moving, and to reduce power consumption of the battery in response to determining that the housing is enclosed.

20. The electronic device of claim 19, further comprising:
an ambient light sensor in the housing configured to make light measurements, wherein the controller is configured to determine whether the housing is enclosed based on the light measurements and the measurements from the pressure sensor.

21. The electronic device of claim 20, wherein the controller is configured to determine whether the housing is enclosed based on the motion measurements, the light measurements, and the measurements from the pressure sensor.

22. The electronic device of claim 19, further comprising:
wireless communications circuitry in the housing, wherein the wireless communications circuitry is configured to be adjusted in response to determining that the housing is enclosed.

23. The electronic device of claim 19, further comprising:
a sensor in the housing, wherein the sensor is configured to be adjusted in response to determining that the housing is enclosed.

24. The electronic device of claim 19, wherein the display is configured to be adjusted in response to determining that the housing is enclosed.
